(19) United States
(12) Patent Application Publication
(10) Pub. No.: US 2021/0333894 A1
(43) Pub. Date: Oct. 28, 2021

(54) PULL TOOL

(71) Applicant: MacLean-Fogg Company, Mundelein, IL (US)

(72) Inventors: Robert WHITNEY, Mundelein, IL (US); Addison WHITNEY, Mundelein, IL (US); Aaron LONGSTREET, Chesterfield, MI (US); Brian DUFFY, Mundelein, IL (US); Jeff DEMUTH, Mundelein, IL (US); David J. DAVIS, Rochester, MI (US)

(73) Assignee: MacLean-Fogg Company, Mundelein, IL (US)

(21) Appl. No.: 17/243,070

(22) Filed: Apr. 28, 2021

Related U.S. Application Data
(60) Provisional application No. 63/022,073, filed on May 8, 2020.
(60) Provisional application No. 63/016,770, filed on Apr. 28, 2020.

(51) Int. Cl. G06F 3/039; B25G 1/10; B67B 7/16

(52) U.S. Cl. CPC G06F 3/0393; B67B 7/16; B25G 1/102

(57) ABSTRACT

A pull tool is provided having a tool body with at least one tool arm extending transverse from a main body and a pointer tip formed at a distal end of the main body. A deformable tip is formed of an elastomer having a conductive additive. The deformable tip secured to and covers the pointer tip of the tool body to provide conductive touch with the deformable tip.

### CROSS-REFERENCE TO RELATED APPLICATIONS

This application claims the benefit of U.S. provisional application Ser. No. 63/016,770 filed Apr. 28, 2020 and U.S. provisional application Ser. No. 63/022,073 filed May 8, 2020, the disclosures of which are hereby incorporated in their entirety by reference herein.

### TECHNICAL FIELD

The present application relates provides a pull tool having a touch tip.

### BACKGROUND

A touch screen may be combination touchpad, computer display or human machine interface that can detect the presence and location of a touch within the display area. The touch lets users interact with a computer by touching the screen directly, fusing the two functions of display and input.

Touch screens are found in nearly every aspect of life. Personal digital devices like smartphones have touch screens. Public digital devices also include touch screens, including bank ATMs, electronic kiosks at stores, ticket vending machines in railway stations, library information and checkout terminals, for example. Touch screens are also used in industrial control applications and can replace traditional switches, buttons, dials, and gauges.

There are many touch screen technologies including resistive, capacitive, infrared optical imaging, surface acoustic wave, electromagnetic induction, infrared, strain gauge, dispersive signal technology, inductive sensor systems that may be placed under an LCD, and acoustic pulse recognition.

Capacitive touch screens are popular for use and provide good durability and react well to electric capacity in humans when a user uses their finger to provide input. However, this type of touch screen does not allow input with a gloved finger, or other non-conductive input device.

### SUMMARY

In at least one embodiment, a pull tool is provided with a tool body formed of a polymer composite with a first conductive additive. The tool body has a tool arm projecting from a main body and a pointer tip formed at a distal end of the main body. A deformable tip is formed of an elastomer having a conductive additive. The deformable tip is secured to and covers the pointer tip of the tool body.

In another embodiment, the pointer tip has a projection extending from a shoulder, wherein the deformable tip abuts the shoulder when secured to the pointer tip.

In another embodiment, the cavity of the deformable tip has a length dimension greater than a length dimension of the projection on the tool body to thereby form an air gap between the projection and the inner surface at the distal end.

In another embodiment, the cavity of the deformable tip has a flange that abuts the shoulder of the tool body and engages at least one undercut slot along the projection with an interference fit to retain the deformable tip on the tool body.

In another embodiment, the tool arm is a hook arm extending transverse from the main body.

In another embodiment, the tool arm is a grip portion having a finger aperture extending from the main body to allow a user to grip the pull tool.

In another embodiment, the tool arm is a hook arm extending transverse from the main body that defines a hook between the hook arm, the main body, and the grip portion, the hook allowing a user to pull an object with the pull tool.

In another embodiment, the tool arm is a keyring aperture.

In another embodiment, the tool body is formed of a polymer of polyoxymethylene (POM).

In another embodiment, the tool body is formed of a photopolymer.

In another embodiment, the tool body is formed of polymer composite with at least 1% carbon additive by weight.

In another embodiment, the tool body is formed of polymer composite with the carbon additive in the range of 2% to 50% by weight.

In another embodiment, the carbon additive is in the range of 3% to 6% by weight.

In another embodiment, the deformable tip is formed of the elastomer with a carbon additive.

In another embodiment, the deformable tip is formed of the elastomer being liquid silicon rubber (LSR).

According to one embodiment, a pull tool is provided having a tool body with at least one tool arm extending transverse from a main body and a pointer tip formed at a distal end of the main body. A deformable tip is formed of an elastomer having a conductive additive. The deformable tip secured to and covers the pointer tip of the tool body to provide conductive touch with the deformable tip.

### BRIEF DESCRIPTION OF THE DRAWINGS

FIG. 1 illustrates a perspective view of a pull tool according to one embodiment of the application.

FIG. 2 illustrates the pull tool in FIG. 1 in use.

FIG. 3 illustrates the pull tool in FIG. 1 in use.

FIG. 4 illustrates a side view of the pull tool in FIG. 1.

FIG. 5 illustrates an exploded side view of a portion of the pull tool in FIG. 4 in detail.

FIG. 6 illustrates top view of a portion of the pull tool in FIG. 5 in detail.

FIG. 7 illustrates a section view along section 7-7 in FIG. 4 showing a portion of the pull tool in detail.

FIG. 8 illustrates another embodiment of a pull tool.

FIGS. 9-12 illustrate a pull tool having various aesthetic designs.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The health and safety during the pandemic brought a whole new set of safety concerns to the forefront. For example, the transmission of germs on touch screens became a concern. The concern with touch screens in personal life such as at kiosks and checkouts, as well as control screens inside factories, among other touch screens such as mobile phones and tablets.

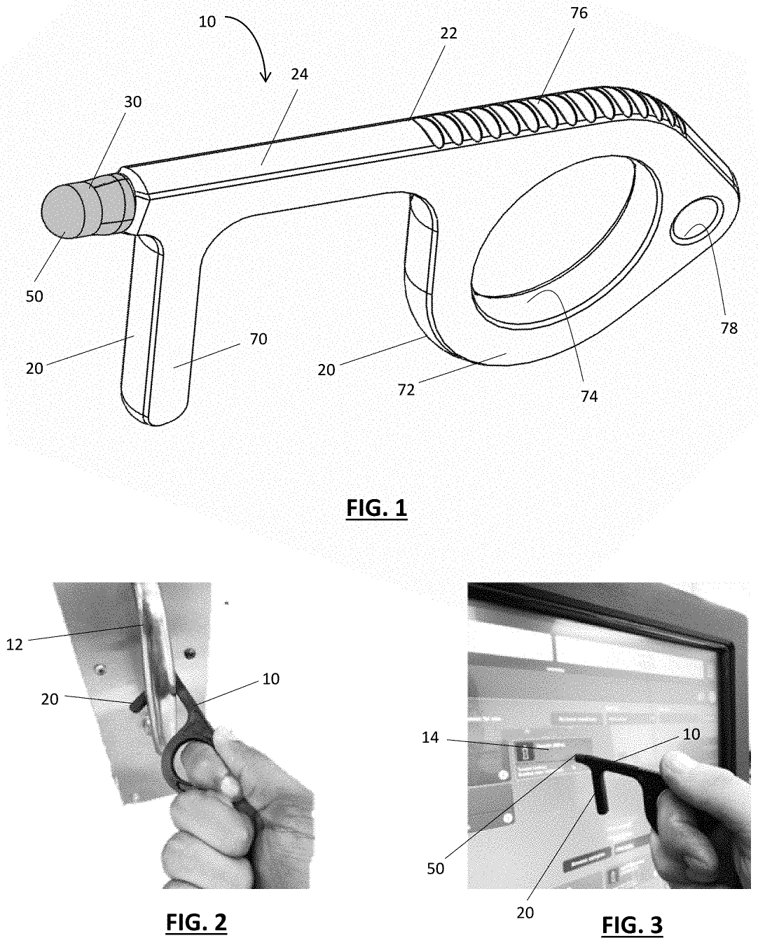

FIG. 1 illustrates a pull tool 10 according to one embodiment that provides a tip 30 for use with touch screens, as well as a tool arm that provides the pull tool with greater functionality. As shown in FIG. 2, the pull tool 10 allows for non-contact opening and manipulations of objects, such as a door handle 12, using a tool arm 20. As shown in FIG. 3, the pull tool 10 may also allow for non-contact touching of objects such as screens 14 and buttons with a pointer tip 30 a having deformable tip 50.

The pull tool 10 has a tool body 22 formed of a polymer composite with a conductive additive. The tool arm 20 projects from a main body 24. The pointer tip 30 (FIG. 5) is formed at a distal end 32 of the main body 24.

The tool body 22 may be formed of a polymer material including a conductive additive that provides conductivity to the tool body. For example, the additives may include carbon, steel, aluminum, brass, copper, graphite or other suitable metallic materials or ferrous metals. By having additives integrally molded with the base material, the entire tool body 22 may be conductive to provide easier non-contact touching of objects such as screens and buttons along any portion of the pull tool 10, including the tool arm 20, for example. The conductive additives may be any suitable additive or quantity that provides conductivity to the pull tool 10.

In at least one embodiment, the tool body 22 is formed of the polymer composite with conductive additive of at least 1% carbon by weight. In another embodiment, the conductive additive may be in the range of 1% to 50% carbon by weight. When greater than approximately 50% carbon or other additive by weight, the strength, rigidity, stiffness, or other mechanical properties may be adversely affected. In another embodiment, the conductive additive may be in the range of 2% to 15% carbon by weight. In another embodiment, the conductive additive may be in the range of 3% to 6% carbon by weight. In another embodiment, the carbon additive may be nominally 4% by weight. The carbon additive may be carbon black, carbon nanotubes, or metal particles.

The polymer material of the tool body 22 may be thermoset or thermoplastic. For example, the polymer material may be acetal or polyoxymethylene (POM), or other suitable polymer material. POM provides high strength, hardness and rigidity so that the tool body 22 is durable. However, other suitable polymers may be used. The tool body 22 with the thermoplastic composite material may formed using injection molding, for example. The thermoplastic material may include the conductive additive and be injection molded.

The polymer of the tool body 22 may also be a photopolymer. The tool body 22 with the photopolymer composite may be formed using 3D printing, stereolithography or additive manufacturing where a light activated resin is cured with light, in particular ultraviolet light. The photopolymer may include the conductive additive to form the tool body 22 with a suitable 3D printing technology. The composite having conductive additive may be any material composite suitable for 3D printing.

In another embodiment, the pull tool 10 may have a tool body 22 formed of a polymer having a metal insert molded in. The metal insert may be molded in along the pointer tip 30. As such, the pointer tip 30 has a plastic outer surface while still providing conductivity. The metal insert may be molded into the pull tool 10 along other surfaces or portions such as the tool arm 20, for example, to provide additional capacitive touch capabilities. In another embodiment, the pull tool 10 having a metal insert pushed in. The metal insert may be retained in the tool body 22 with an interference fit, or may be retained with adhesive, for example. The metal insert may be pushed into a cavity formed along the projection tip 30. The metal insert may also be pushed into a cavity formed in the pull tool 10 along other surfaces or portions such as the tool arm 20, for example.

The pull tool 10 also has a deformable tip 50. The deformable tip 50 is formed of an elastomer having a conductive additive. The deformable tip 50 is secured to and covers the pointer tip 30 of the tool body 22. The pointer tip allows mechanical engagement and interaction without the user having to use their hands or fingers. The pointer tip may also include a nub or feature that provides resistive touch engagement, capacitive touch engagement, surface acoustic wave engagement, optical touchscreen engagement, electromagnetic engagement, or other suitable touch engagement.

The deformable tip 50 may be formed of the elastomer with a durometer that allows the tip 50 to deform as it is pressed against a flat surface such as a touch screen. As the tip 50 deforms, the contact area increases providing increased capacitance and tactile grip.

For example, the deformable tip 50 may be formed of rubber, such as liquid silicon rubber (LSR) or other suitable material. The deformable tip 50 is also conductive and may be formed with the elastomer with a carbon additive, such as carbon black. Other conductive additives may also be used, similar as discussed above with regard to the tool body.

The deformable material is elastomeric but adding carbon to the rubber or other elastomeric material to provide conductivity may stiffen the composite. To maintain the deformable properties and tactile grip as the tip 50 deforms, the touch tool 10 may have an internal air gap 52, as shown in more detail in section view in FIG. 7.

As shown in FIG. 5, the pointer tip 30 on the tool body 22 has a projection 34 extending from a shoulder 36. As illustrated, the projection 34 may be generally cylindrical and have a hemispherical end. The projection 34 may be any suitable shape such as conical, frustoconical, chamfered, curved, etc.

The deformable tip 50 has an inner cavity with an inner surface 54. The inner surface 54 engages the projection 34 to retain the deformable tip 50 on the tool body 22. A flange 60 on the deformable tip 50 abuts the shoulder 36 when the tip 50 is fully seated and secured to the tool body 22. As shown in the top view in FIG. 6, the projection 34 has an undercut defining a pair of slots 40. The flange 60 may extend radially and engage the slots 40 to secure the deformable tip 50 to the tool body 22 with an interference fit such as a snap-fit. The pair of slots 40 are formed on opposite sides of the projection 34 to allow for ease of manufacturing from injection molding. In another embodiment, the slot may extend radially around the projection 34. The inner surface 54 may also engage and be pressed on to the projection 34 along the cylindrical circumference with an interference fit.

The inner cavity of the deformable tip 50 has a length dimension greater than a length dimension of the projection 34 to thereby form the air gap 52 between the projection 34 and the inner surface 54 at the distal end 32. The air gap 52 has a dimension A being at least 0.05 mm. In another embodiment, the air gap 52 is in the range of 0.05 mm to 4 mm. In another embodiment, the air gap 52 may be in the range of 0.5 mm to 2.5 mm. Nominally, the air gap may be generally 1.5 mm.

To ensure proper deformation and durometer of the deformable tip 50, a distal end portion 56 of the deformable tip 50 may have relatively thin wall thickness compared to side wall 58 portions and a flange 60. As shown, the wall thickness of the end portion 56 is less than the side walls 58 and flange 60.

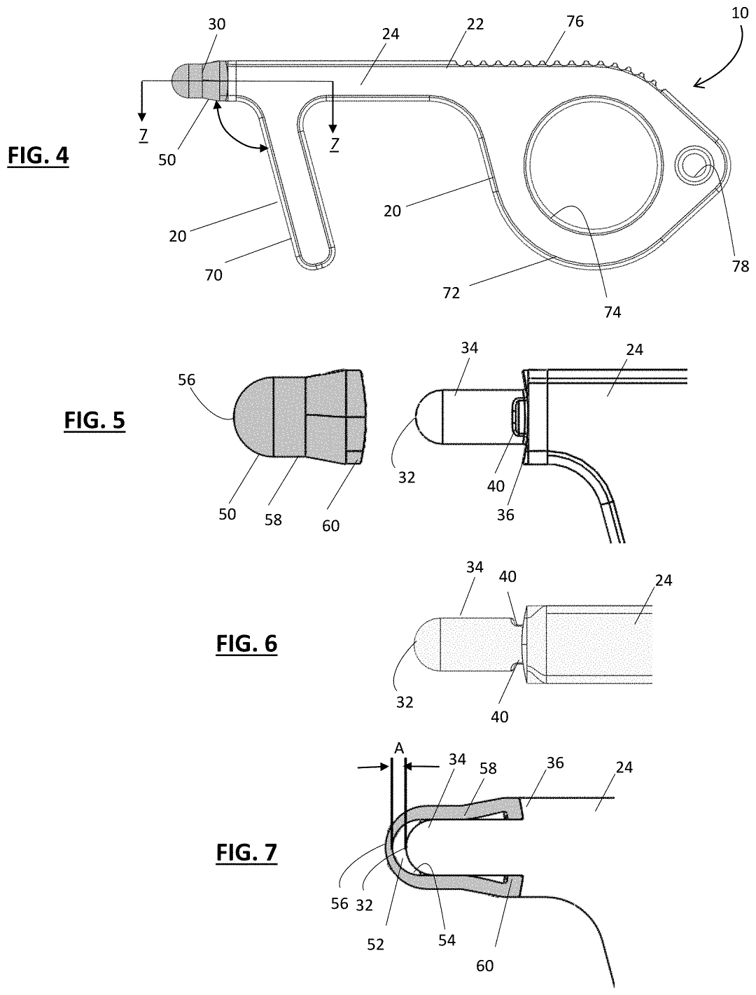

As further illustrated in FIGS. 1-4, the pull tool 10 also has at least one tool arm extending transverse from the main body 24. The main body 24 may extend generally linearly from the pointer tip 30. The tool arms 20 may extend transversely from the main body 24.

In one embodiment, the pull tool 10 has a hook arm 70 and a grip portion 72 that extend transversely from the main body 24. The hook arm 70 defines an open hook between the hook arm 70, the main body 24, and the grip portion 72. As shown in FIG. 2, the hook allows a user to pull an object with the tool, such as a door handle. The hook arm 70 is positioned adjacent the pointer tip 30. As shown in FIGS. 1-4, the hook arm 70 is generally linear and projects at an obtuse angle relative to the pointer tip 30. However, the hook arm 70 may be curved, or extend at various angles for various applications or uses.

As shown in FIG. 1, the grip portion 72 is formed adjacent an opposite end of the pull tool 10. The grip portion 72 allows a user to easily grip the tool. The grip potion 72 may have a finger aperture 74 extending from the main body 24 that allows a user to securely hold the tool 10 with one finger, as shown in FIGS. 2-3. The grip portion 72 may also include a contoured grip segment 76 along the main body 24 adjacent the finger aperture 74. The contoured grip segment may be formed with plurality of grooves, as shown, or may be another suitable contour that provides increased tactile grip for the user.

The pull tool 10 also has a keyring aperture 78. As shown, the keyring aperture 78 is positioned along the grip potion 72, however the keyring aperture may be positioned at any suitable location.

The pull tool 10 is sized to be easily carried, such as on a keyring, or in a user's pocket or purse. The pull tool 10 can be inserted into existing covers or pockets currently used to store currency, credit cards, etc. For example, in the embodiment illustrated, the pull tool 10 has a length of 100 mm, a height of 38 mm and a thickness of 6 mm.

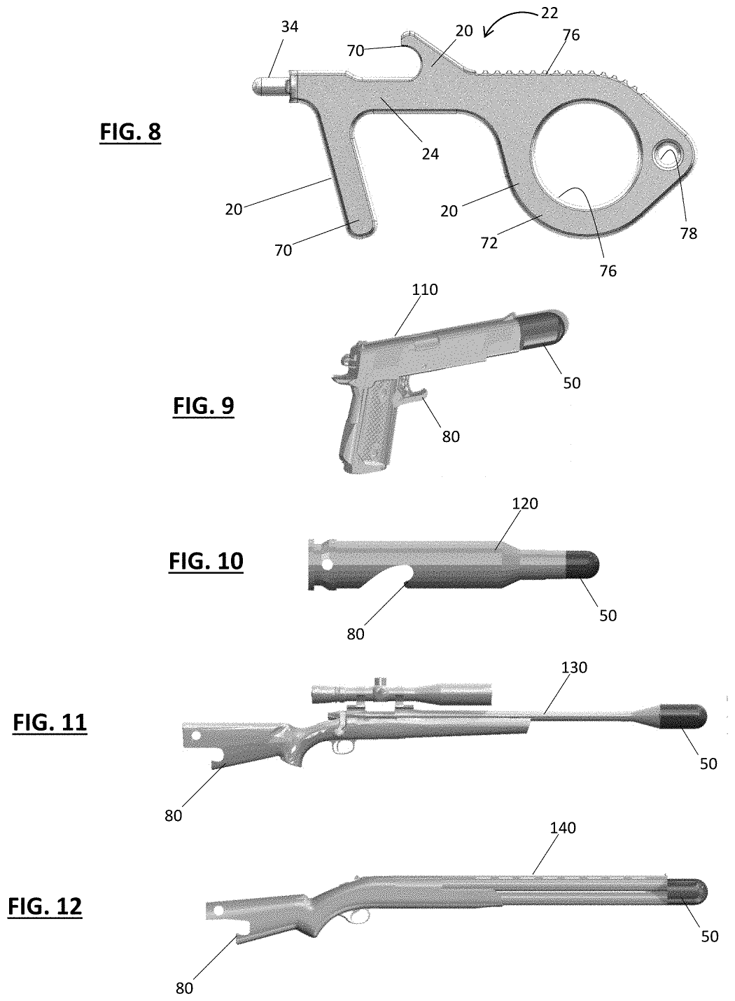

FIG. 8 illustrates another embodiment of a pull tool 10 with a tool arm 20 being a bottle opener 80 for hand opening of capped bottles. As shown in FIG. 8, the bottle opener 80 may extend from an opposite side of the main body 24. The pull tool may be formed of a material composite stiff enough to provide durability for use as a bottle opener without additional inserts or components.

FIGS. 9-12 illustrate various aesthetic design of the pull tool. For example, FIG. 9 shows a tool body 110 shaped like a pistol and having a deformable tip 50 for use with a touch screen and a tool arm 20 being a bottle opener. FIG. 8 shows a tool body 120 shaped like a cartridge and having a deformable tip 50. FIG. 9 shows a tool body 130 shaped like a rifle and having a deformable tip 50. FIG. 10 shows a tool body 110 shaped like a shotgun and having a deformable tip 50. The pull tool may be formed as other aesthetic designs and shapes.

The pull tool 10 may be attached to a user's mobile phone case so that the hook arm projects beyond the periphery of the case to provide an extension of the user's arm. The pull tool 10 may be moveable between a usage position and a stowed position.

In one embodiment, a pull tool is attached to rotate or hinge relative to a mobile phone case. A rotation element may be molded or integrated into the mobile phone case. The rotation element may be used with existing accessories on mobile phone cases, such as collapsible grips or extendable buttons, for example. The rotation element may engage the finger aperture. In the non-use position/stowed position, the pull tool is concealed behind the phone so that the hook arm and pointer tip do not extend beyond the periphery of the phone. The grabber key is rotated to a usage position where the hook arm extends beyond the periphery of the phone to allow a person to grab and manipulate objects. The device can be rotated to many different angles for usage (up to 360 degrees). A user can hold either the pull tool or phone or both while in use.

In another embodiment, the pull tool 10 may be formed of a material having microbial properties to minimize germ (virus, bacteria and other microscopic particles) transfer via surfaces.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A pull tool comprising:
a tool body formed of a polymer composite with a first conductive additive, the tool body having a tool arm projecting from a main body and a pointer tip formed at a distal end of the main body; and
a deformable tip formed of an elastomer having a conductive additive, the deformable tip secured to and covering the pointer tip of the tool body.

2. The pull tool of claim 1, wherein the pointer tip has a projection extending from a shoulder, wherein the deformable tip abuts the shoulder when secured to the pointer tip.

3. The pull tool of claim 2, wherein the cavity of the deformable tip has a length dimension greater than a length dimension of the projection on the tool body to thereby form an air gap between the projection and the inner surface at the distal end.

4. The pull tool of claim 2, wherein the cavity of the deformable tip has a flange that abuts the shoulder of the tool body and engages at least one undercut slot along the projection with an interference fit to retain the deformable tip on the tool body.

5. The pull tool of claim 1, wherein the tool arm comprises a hook arm extending transverse from the main body.

6. The pull tool of claim 1, wherein the tool arm comprises a grip portion having a finger aperture extending from the main body to allow a user to grip the pull tool.

7. The pull tool of claim 6, wherein the tool arm comprises a hook arm extending transverse from the main body that defines a hook between the hook arm, the main body, and the grip portion, the hook allowing a user to pull an object with the pull tool.

8. The pull tool of claim 1, wherein the tool arm comprises a keyring aperture.

9. The pull tool of claim 1, wherein the tool body is formed of a polymer comprising polyoxymethylene (POM).

10. The pull tool of claim 1, wherein the tool body is formed of a polymer comprising a photopolymer.

11. The pull tool of claim 1, wherein the tool body is formed of polymer composite with at least 1% carbon additive by weight.

12. The pull tool of claim 11, wherein the tool body is formed of polymer composite with the carbon additive in the range of 2% to 50% by weight.

13. The pull tool of claim 12, wherein the carbon additive is in the range of 3% to 6% by weight.

14. The pull tool of claim 1, wherein the deformable tip is formed of the elastomer with a carbon additive.

15. The pull tool of claim 14, wherein the deformable tip is formed of the elastomer comprising liquid silicon rubber (LSR).

16. A pull tool comprising:
a tool body having at least one tool arm extending transverse from a main body and a pointer tip formed at a distal end of the main body; and
a deformable tip formed of an elastomer having a conductive additive, the deformable tip secured to and covering the pointer tip of the tool body to provide conductive touch with the deformable tip.

17. The pull tool of claim 16, wherein the tool arm comprises at least one of a hook arm, a keyring aperture, a grip portion or a bottle opener extending transverse from the main body.

18. The pull tool of claim 16, wherein the tool body is formed of polymer composite having a conductive additive to provide conductive touch along the entire tool body.

19. The pull tool of claim 16, wherein the conductive additive is least 1% carbon additive by weight.

20. The pull tool of claim 16, wherein the pointer tip has a projection extending from a shoulder, wherein the deformable tip abuts the shoulder when secured to the pointer tip,
wherein the cavity of the deformable tip has a length dimension greater than a length dimension of the projection on the tool body to thereby form an air gap between the projection and the inner surface at the distal end.
